(19) United States
(12) Patent Application Publication
(10) Pub. No.: US 2025/0209802 A1
(43) Pub. Date: Jun. 26, 2025

(54) ARTIFICIAL INTELLIGENCE DEVICE FOR LIGHT TRANSFORMER-BASED EMOTION RECOGNITION (LTER) AND METHOD THEREOF

(71) Applicant: LG ELECTRONICS INC., Seoul (KR)

(72) Inventors: Harmanpreet SINGH, Toronto (CA); Homa FASHANDI, Toronto (CA); Amirhossein HAJAVI, Toronto (CA)

(73) Assignee: LG ELECTRONICS INC., Seoul (KR)

(21) Appl. No.: 19/000,028

(22) Filed: Dec. 23, 2024

Related U.S. Application Data
(60) Provisional application No. 63/613,696, filed on Dec. 21, 2023.

(51) Int. Cl. G06V 10/80; G06V 40/16; G10L 15/26; G10L 25/63

(52) U.S. Cl. CPC G06V 10/806; G06V 40/176; G10L 15/26; G10L 25/63

(57) ABSTRACT

A method for controlling an artificial intelligence (AI) deice to perform emotion recognition can include receiving a video segment including a plurality of frames and an audio signal, processing the audio signal, by an audio encoder, to generate an audio embedding, and processing the video segment, by a visual encoder, to generate a visual embedding. Also, the method can include processing the audio embedding, by an audio transformer, to generate an audio feature vector, a key matrix and a value matrix, processing the visual embedding, by a visual transformer, to generate a visual feature vector based on cross-attention using the key matrix and the value matrix from the audio transformer, generating a fused output using a fusion module that combines at least the audio feature vector and the visual feature vector, and generating an emotion prediction using a classifier module that analyzes the fused output, and outputting the emotion prediction.

### CROSS-REFERENCE TO RELATED APPLICATIONS

This non-provisional application claims priority under 35 U.S.C. § 119(e) to U.S. Provisional Application No. 63/613,696, filed on Dec. 21, 2023, the entirety of which is hereby expressly incorporated by reference into the present application.

### BACKGROUND

### Field

The present disclosure relates to a device and method for emotion recognition, in the field of artificial intelligence (AI). Particularly, the method can efficiently and accurately perform emotion recognition using multimodal data, such as audio and visual information.

### Discussion of the Related Art

Artificial intelligence (AI) continues to transform various aspects of society and help users by powering advancements in various fields, particularly with regards to interactive applications.

Emotion recognition plays an important role in human-computer interaction. For example, accurate emotion recognition can help enable more natural and empathetic communication between humans and machines, better understand a user's intent, and provide more useful responses and results.

However, existing approaches to emotion recognition suffer from several limitations. For example, existing models often rely on overly complex and computationally expensive systems. This complexity can hinder real-time applications and deployment on resource-constrained devices.

Further, existing methods may over rely on textual language for determining emotional states, which can lead to less accurate emotion recognition, especially when audio cues may be dominant (e.g., tone of voice or vocal inflections) or when textual language information may be misleading (e.g., when using sarcasm).

Also, existing methods that use multiple modalities often employ generic feature extractors that are not specifically designed for emotion recognition. This can result in less effective feature representations and lower accuracy in emotion classification. For example, such systems may use utilize complex feature extraction pipelines that negatively impact performance and latency.

In addition, some emotion recognition systems require transmitting raw video and audio data to a remote server for processing, which raises privacy concerns. This can limit the applicability of such systems in sensitive environments where data privacy and security are needed.

Thus, existing emotion recognition technology faces various challenges related to complexity, efficiency, feature extraction, over-reliance on language and privacy.

Accordingly, there exists a need for a method that can achieve accurate and efficient emotion recognition. For example, there exists a need for an emotion recognition solution that can prioritize audio as a primary modality.

Further, a need exists for a method that can achieve a lighter and more efficient model without significantly sacrificing performance, which can facilitate deployment on resource-constrained devices and better support real-time applications. Also, a need exists for a method for emotion recognition that can provide more effective feature representations and improved accuracy.

For instance, there is a need for a more efficient, accurate and privacy-conscious solution for emotion recognition.

### SUMMARY OF THE DISCLOSURE

The present disclosure has been made in view of the above problems and it is an object of the present disclosure to provide a device and method that can provide emotion recognition, in the field of artificial intelligence (AI). Further, the method can provide a more efficient, accurate and privacy-conscious solution for emotion recognition.

An object of the present disclosure is to provide an artificial intelligence (AI) device and method for emotion recognition that can process audio and visual inputs (and optionally text), in which the audio can be treated as the primary modality for conveying emotions, and a specialized, lightweight visual encoder that is specifically trained for facial expression recognition can extract key features from the visual data. Then, the extracted visual features and the audio information can be analyzed to identify the expressed emotion. In this way, by focusing on audio as the primary modality coupled with the use of a lightweight and specialized visual encoder, a more efficient and accurate emotion recognition system can be provided. Also, this streamlined approach can allow for broader application and deployment across various devices and platforms.

Another object of the present disclosure is to provide a method for controlling an artificial intelligence (AI) device that can include receiving, by a processor in the AI device, a video segment including a plurality of frames and an audio signal corresponding to the video segment, processing the audio signal, by an audio encoder, to generate an audio embedding, processing the video segment, by a visual encoder, to generate a visual embedding, processing the audio embedding, by an audio transformer, to generate an audio feature vector, a key matrix and a value matrix, processing the visual embedding, by a visual transformer, to generate a visual feature vector, wherein the processing the visual embedding includes performing cross-attention based on the key matrix and the value matrix from the audio transformer, generating a fused output using a fusion module that combines at least the audio feature vector and the visual feature vector, and generating an emotion prediction using a classifier module that analyzes the fused output, and outputting the emotion prediction.

It is another object of the present disclosure to provide a method, which the processing the video segment by the visual encoder includes extracting, via a facial expression recognition (FER) model in the visual encoder, a plurality of visual embeddings corresponding to the plurality of frames in the video segment, and averaging at least some of the plurality of visual embeddings over a time window to generate an average feature vector corresponding to a group of frames, and transmitting the average feature vector to the video transformer.

Yet another object of the present disclosure is to provide a method, in which the FER model is trained in two stages that include pre-training on face recognition and then fine-tuning on emotion classification.

An object of the present disclosure to provide a method, in which each of the audio transformer and the visual transform is a transform tower including a plurality of transformer blocks.

Another object of the present disclosure to provide a method, in which each of the plurality of transformer blocks includes a multi-head attention block, a first add and normalize block, a feed forward block, a second add and normalize block, a glimpse block, and a third add and normalize block.

An object of the present disclosure to provide a method, in which the generating the fused output using the fusion module includes element-wise summing the audio feature vector and the visual feature vector to generate the fused output.

Yet another object of the present disclosure to provide a method that includes inputting the audio signal to a speech to text (STT) engine to convert speech included in the audio signal to text, processing the text, by a text encoder, to generate a text embedding, processing the text embedding, by a text transformer, to generate a text feature vector based on performing cross-attention using the key matrix and the value matrix from the audio transformer, and generating the fused output using the fusion module to combine the audio feature vector, the visual features vector and the text feature vector.

An object of the present disclosure to provide a method, in which each word in the text is embedded in a vector of 300 dimensions based on GloVe.

Another object of the present disclosure to provide a method, in which the generating the emotion prediction using the classifier module includes mapping the fused output to a set of probabilities corresponding to a plurality of emotions, and selecting an emotion among the plurality of emotions having a highest probability as the emotion prediction.

An object of the present disclosure to provide a method, in which the plurality of emotions include anger, disgust, fear, happiness, sadness and surprise.

Another object of the present disclosure is to provide an artificial intelligence (AI) device including a memory configured to store video and audio information, and a controller configured to receive a video segment including a plurality of frames and an audio signal corresponding to the video segment, process the audio signal, by an audio encoder, to generate an audio embedding, process the video segment, by a visual encoder, to generate a visual embedding, process the audio embedding, by an audio transformer, to generate an audio feature vector, a key matrix and a value matrix, process the visual embedding, by a visual transformer, to generate a visual feature vector based on performing cross-attention using the key matrix and the value matrix from the audio transformer, generate a fused output using a fusion module that combines at least the audio feature vector and the visual feature vector, and generate an emotion prediction using a classifier module that analyzes the fused output, and output the emotion prediction.

In addition to the objects of the present disclosure as mentioned above, additional objects and features of the present disclosure will be clearly understood by those skilled in the art from the following description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 illustrates an AI device according to an embodiment of the present disclosure.

FIG. 2 illustrates an AI server according to an embodiment of the present disclosure.

FIG. 3 illustrates an AI device according to an embodiment of the present disclosure.

FIG. 4 illustrates an example flow chart for a method of controlling an AI device to perform emotion recognition according to an embodiment of the present disclosure.

FIG. 5 illustrates an overview of the architecture of an AI model for emotion recognition, according to an embodiment of the present disclosure.

FIG. 6 illustrates an internal architecture of a transformer block, according to an embodiment of the present disclosure.

### DETAILED DESCRIPTION OF THE EMBODIMENTS

Reference will now be made in detail to the embodiments of the present disclosure, examples of which are illustrated in the accompanying drawings.

Wherever possible, the same reference numbers will be used throughout the drawings to refer to the same or like parts.

Advantages and features of the present disclosure, and implementation methods thereof will be clarified through following embodiments described with reference to the accompanying drawings.

The present disclosure can, however, be embodied in different forms and should not be construed as limited to the embodiments set forth herein.

Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details.

Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description. In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms.

These terms are only used to distinguish one element from another. For example, a first element could be termed a second element, and, similarly, a second element could be termed a first element, without departing from the scope of the present disclosure.

Further, “X-axis direction,” “Y-axis direction” and “Z-axis direction” should not be construed by a geometric relation only of a mutual vertical relation and can have broader directionality within the range that elements of the present disclosure can act functionally.

The term “at least one” should be understood as including any and all combinations of one or more of the associated listed items.

For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship.

Hereinafter, the preferred embodiments of the present disclosure will be described in detail with reference to the accompanying drawings. All the components of each device or apparatus according to all embodiments of the present disclosure are operatively coupled and configured.

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and can mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network can include an input layer, an output layer, and optionally one or more hidden layers. Each layer includes one or more neurons, and the artificial neural network can include a synapse that links neurons to neurons. In the artificial neural network, each neuron can output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network can be to determine the model parameters that minimize a loss function. The loss function can be used as an index to determine optimal model parameters in the learning process of the artificial neural network.

Machine learning can be classified into supervised learning, unsupervised learning, and reinforcement learning according to a learning method.

The supervised learning can refer to a method of learning an artificial neural network in a state in which a label for learning data is given, and the label can mean the correct answer (or result value) that the artificial neural network must infer when the learning data is input to the artificial neural network. The unsupervised learning can refer to a method of learning an artificial neural network in a state in which a label for learning data is not given. The reinforcement learning can refer to a learning method in which an agent defined in a certain environment learns to select a behavior or a behavior sequence that maximizes cumulative compensation in each state.

Machine learning, which can be implemented as a deep neural network (DNN) including a plurality of hidden layers among artificial neural networks, is also referred to as deep learning, and the deep learning is part of machine learning. In the following, machine learning is used to mean deep learning.

Self-driving refers to a technique of driving for oneself, and a self-driving vehicle refers to a vehicle that travels without an operation of a user or with a minimum operation of a user.

For example, the self-driving can include a technology for maintaining a lane while driving, a technology for automatically adjusting a speed, such as adaptive cruise control, a technique for automatically traveling along a predetermined route, and a technology for automatically setting and traveling a route when a destination is set.

The vehicle can include a vehicle having only an internal combustion engine, a hybrid vehicle having an internal combustion engine and an electric motor together, and an electric vehicle having only an electric motor, and can include not only an automobile but also a train, a motorcycle, and the like.

At this time, the self-driving vehicle can be regarded as a robot having a self-driving function.

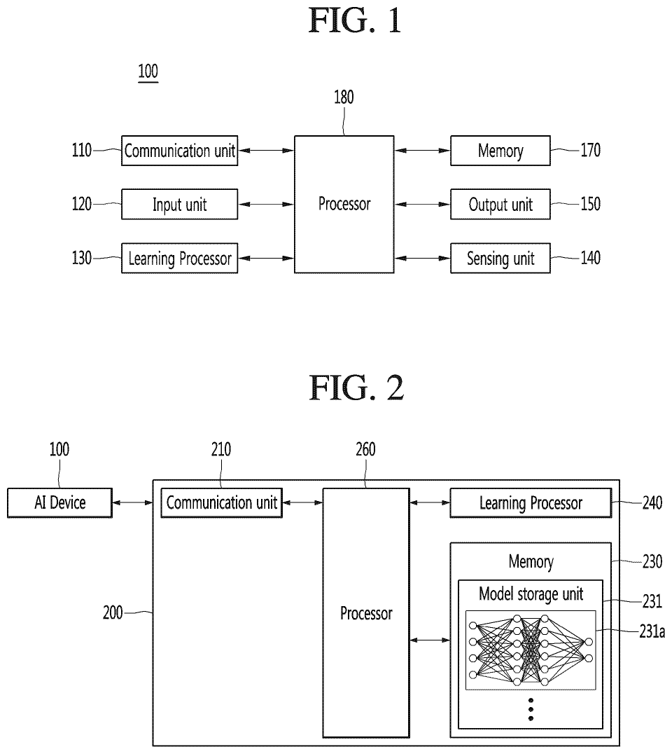

FIG. 1 illustrates an artificial intelligence (AI) device 100 according to one embodiment.

The AI device 100 can be implemented by a stationary device or a mobile device, such as a television (TV), a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like. However, other variations are possible.

Referring to FIG. 1, the AI device 100 can include a communication unit 110 (e.g., transceiver), an input unit 120 (e.g., touchscreen, keyboard, mouse, microphone, etc.), a learning processor 130, a sensing unit 140 (e.g., one or more sensors or one or more cameras), an output unit 150 (e.g., a display or speaker), a memory 170, and a processor 180 (e.g., a controller).

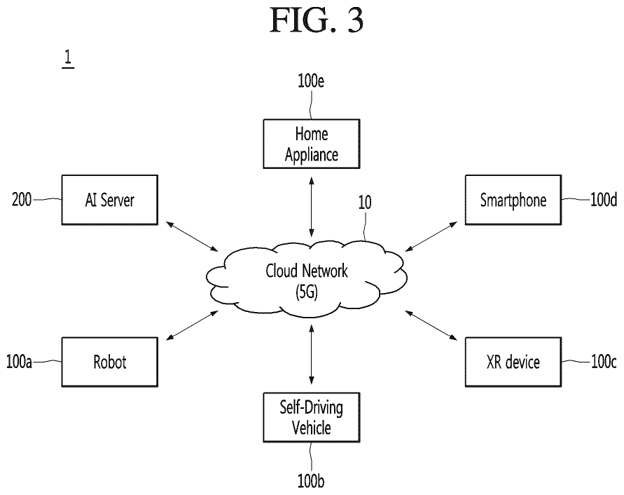

The communication unit 110 (e.g., communication interface or transceiver) can transmit and receive data to and from external devices such as other AI devices 100a to 100e and the AI server 200 (e.g., FIGS. 2 and 3) by using wire/wireless communication technology. For example, the communication unit 110 can transmit and receive sensor information, a user input, a learning model, and a control signal to and from external devices.

The communication technology used by the communication unit 110 can include GSM (Global System for Mobile communication), CDMA (Code Division Multi Access), LTE (Long Term Evolution), 5G, WLAN (Wireless LAN), Wi-Fi (Wireless-Fidelity), BLUETOOTH, RFID (Radio Frequency Identification), Infrared Data Association (IrDA), ZIGBEE, NFC (Near Field Communication), and the like.

The input unit 120 can acquire various kinds of data.

At this time, the input unit 120 can include a camera for inputting a video signal, a microphone for receiving an audio signal, and a user input unit for receiving information from a user. The camera or the microphone can be treated as a sensor, and the signal acquired from the camera or the microphone can be referred to as sensing data or sensor information.

The input unit 120 can acquire a learning data for model learning and an input data to be used when an output is acquired by using a learning model. The input unit 120 can acquire raw input data. In this situation, the processor 180 or the learning processor 130 can extract an input feature by preprocessing the input data.

The learning processor 130 can learn a model composed of an artificial neural network by using learning data. The learned artificial neural network can be referred to as a learning model. The learning model can be used to infer a result value for new input data rather than learning data, and the inferred value can be used as a basis for determination to perform a certain operation.

At this time, the learning processor 130 can perform AI processing together with the learning processor 240 of the AI server 200.

At this time, the learning processor 130 can include a memory integrated or implemented in the AI device 100. Alternatively, the learning processor 130 can be implemented by using the memory 170, an external memory directly connected to the AI device 100, or a memory held in an external device.

The sensing unit 140 can acquire at least one of internal information about the AI device 100, ambient environment information about the AI device 100, and user information by using various sensors.

Examples of the sensors included in the sensing unit 140 can include a proximity sensor, an illuminance sensor, an acceleration sensor, a magnetic sensor, a gyro sensor, an inertial sensor, an RGB sensor, an IR (infrared) sensor, a fingerprint recognition sensor, an ultrasonic sensor, an optical sensor, a camera, a microphone, a lidar, and a radar.

The output unit 150 can generate an output related to a visual sense, an auditory sense, or a haptic sense.

At this time, the output unit 150 can include a display unit for outputting time information, a speaker for outputting auditory information, and a haptic module for outputting haptic information.

The memory 170 can store data that supports various functions of the AI device 100. For example, the memory 170 can store input data acquired by the input unit 120, learning data, a learning model, a learning history, and the like.

The processor 180 can determine at least one executable operation of the AI device 100 based on information determined or generated by using a machine learning algorithm. The processor 180 can control the components of the AI device 100 to execute the determined operation. For example, the processor 180 can implement a light transformer based emotion recognition (LTER) AI model to recognize and identify emotions based on a plurality of modalities. Also, the identified emotions can be used by AI systems in various downstream related tasks.

To this end, the processor 180 can request, search, receive, or utilize data of the learning processor 130 or the memory 170. The processor 180 can control the components of the AI device 100 to execute the predicted operation or the operation determined to be desirable among the at least one executable operation.

When the connection of an external device is required to perform the determined operation, the processor 180 can generate a control signal for controlling the external device and can transmit the generated control signal to the external device.

The processor 180 can acquire information from the user input and can determine an emotional state of the user and produce an answer to a query, carry out an action or movement, animate a displayed avatar or a recommend an item or action based on the determined emotional state.

The processor 180 can acquire the information corresponding to the user input by using at least one of a speech to text (STT) engine for converting speech input into a text string or a natural language processing (NLP) engine for acquiring intention information of a natural language.

At least one of the STT engine or the NLP engine can be configured as an artificial neural network, at least part of which is learned according to the machine learning algorithm. At least one of the STT engine or the NLP engine can be learned by the learning processor 130, can be learned by the learning processor 240 of the AI server 200 (see FIG. 2), or can be learned by their distributed processing.

The processor 180 can collect history information including user profile information, the operation contents of the AI device 100 or the user's feedback on the operation and can store the collected history information in the memory 170 or the learning processor 130 or transmit the collected history information to the external device such as the AI server 200. The collected history information can be used to update the learning model.

The processor 180 can control at least part of the components of AI device 100 to drive an application program stored in memory 170. Furthermore, the processor 180 can operate two or more of the components included in the AI device 100 in combination to drive the application program.

FIG. 2 illustrates an AI server according to one embodiment.

Referring to FIG. 2, the AI server 200 can refer to a device that learns an artificial neural network by using a machine learning algorithm or uses a learned artificial neural network. The AI server 200 can include a plurality of servers to perform distributed processing, or can be defined as a 5G network, 6G network or other communications network. At this time, the AI server 200 can be included as a partial configuration of the AI device 100, and can perform at least part of the AI processing together.

The AI server 200 can include a communication unit 210, a memory 230, a learning processor 240, a processor 260, and the like.

The communication unit 210 can transmit and receive data to and from an external device such as the AI device 100.

The memory 230 can include a model storage unit 231. The model storage unit 231 can store a learning or learned model (or an artificial neural network 231a) through the learning processor 240.

The learning processor 240 can learn the artificial neural network 231a by using the learning data. The learning model can be used in a state of being mounted on the AI server 200 of the artificial neural network, or can be used in a state of being mounted on an external device such as the AI device 100.

The AI model can be implemented in hardware, software, or a combination of hardware and software. If all or part of the learning models are implemented in software, one or more instructions that constitute the learning model can be stored in the memory 230.

The processor 260 can infer the result value for new input data by using the AI model and can generate a response or a control command based on the inferred result value.

FIG. 3 illustrates an AI system 1 including a terminal device according to one embodiment.

Referring to FIG. 3, in the AI system 1, at least one of an AI server 200, a robot 100a, a self-driving vehicle 100b, an XR (extended reality) device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, can be referred to as AI devices 100a to 100e. The AI server 200 of FIG. 3 can have the configuration of the AI server 200 of FIG. 2.

According to an embodiment, the method can be implemented as an interactive application or program that can be downloaded or installed in the smartphone 100d, which can communicate with the AI server 200, but embodiments are not limited thereto.

The cloud network 10 can refer to a network that forms part of a cloud computing infrastructure or exists in a cloud computing infrastructure. The cloud network 10 can be configured by using a 3G network, a 4G or LTE network, a 5G network, a 6G network, or other network.

For instance, the devices 100a to 100e and 200 configuring the AI system 1 can be connected to each other through the cloud network 10. In particular, each of the devices 100a to 100e and 200 can communicate with each other through a base station, but can directly communicate with each other without using a base station.

The AI server 200 can include a server that performs AI processing and a server that performs operations on big data. According to embodiments, the LTER model can be fully implemented on an edge device (e.g., locally on devices 100a to 100e) or fully implemented AI server 200 in which an edge device collected the raw audio and video signals to provide to the AI server 200. According to another embodiment, parts of the LTER model can be distributed across both of an edge device and the AI server 200.

The AI server 200 can be connected to at least one of the AI devices constituting the AI system 1, that is, the robot 100a, the self-driving vehicle 100b, the XR device 100c, the smartphone 100d, or the home appliance 100e through the cloud network 10, and can assist at least part of AI processing of the connected AI devices 100a to 100e.

At this time, the AI server 200 can learn the artificial neural network according to the machine learning algorithm instead of the AI devices 100a to 100e, and can directly store the learning model or transmit the AI model to the AI devices 100a to 100e.

Further, the AI server 200 can receive input data from the AI devices 100a to 100e, can infer the result value for the received input data by using the AI model, can generate a response or a control command based on the inferred result value, and can transmit the response or the control command to the AI devices 100a to 100e. Each AI device 100a to 100e can have the configuration of the AI device 100 of FIGS. 1 and 2 or other suitable configurations.

Alternatively, the AI devices 100a to 100e can infer the result value for the input data by directly using the learning model, and can generate the response or the control command based on the inference result.

Hereinafter, various embodiments of the AI devices 100a to 100e to which the above-described technology is applied will be described. The AI devices 100a to 100e illustrated in FIG. 3 can be regarded as a specific embodiment of the AI device 100 illustrated in FIG. 1.

According to an embodiment, the home appliance 100e can be a smart television (TV), smart microwave, smart oven, smart refrigerator or other display device, which can implement one or more of a digital avatar assistant, a question and answering system or a recommendation system, etc. The method can be the form of an executable application or program.

The robot 100a, to which the AI technology is applied, can be implemented as an entertainment robot, a guide robot, a carrying robot, a cleaning robot, a wearable robot, a pet robot, an unmanned flying robot, a home robot, a care robot or the like.

The robot 100a can include a robot control module for controlling the operation, and the robot control module can refer to a software module or a chip implementing the software module by hardware.

The robot 100a can acquire state information about the robot 100a by using sensor information acquired from various kinds of sensors, can detect (recognize) surrounding environment and objects, can generate map data, can determine the route and the travel plan, can determine the response to user interaction, or can determine the operation.

The robot 100a can use the sensor information acquired from at least one sensor among the lidar, the radar, and the camera to determine the travel route and the travel plan.

The robot 100a can perform the above-described operations by using the AI model composed of at least one artificial neural network. For example, the robot 100a can recognize the surrounding environment and the objects by using the AI model, and can determine the operation by using the recognized surrounding information or object information. The learning model can be learned directly from the robot 100a or can be learned from an external device such as the AI server 200.

At this time, the robot 100a can perform the operation by generating the result by directly using the AI model, but the sensor information can be transmitted to the external device such as the AI server 200 and the generated result can be received to perform the operation.

The robot 100a can use at least one of the map data, the object information detected from the sensor information, or the object information acquired from the external apparatus to determine the travel route and the travel plan, and can control the driving unit such that the robot 100a travels along the determined travel route and travel plan. Further, the robot 100a can determine an action to pursue or an item to recommend. Also, the robot 100a can generate an answer in response to a user query and the robot 100a can have animated facial expressions. The answer can be in the form of natural language.

The map data can include object identification information about various objects arranged in the space in which the robot 100a moves. For example, the map data can include object identification information about fixed objects such as walls and doors and movable objects such as desks. The object identification information can include a name, a type, a distance, and a position.

In addition, the robot 100a can perform the operation or travel by controlling the driving unit based on the control/interaction of the user. At this time, the robot 100a can acquire the intention information of the interaction due to the user's operation or speech utterance, and can determine the response based on the acquired intention information, and can perform the operation while providing an animated face.

The robot 100a, to which the AI technology and the self-driving technology are applied, can be implemented as a guide robot, a carrying robot, a cleaning robot (e.g., an automated vacuum cleaner), a wearable robot, an entertainment robot, a pet robot, an unmanned flying robot (e.g., a drone or quadcopter), or the like.

The robot 100a, to which the AI technology and the self-driving technology are applied, can refer to the robot itself having the self-driving function or the robot 100a interacting with the self-driving vehicle 100b.

The robot 100a having the self-driving function can collectively refer to a device that moves for itself along the given movement line without the user's control or moves for itself by determining the movement line by itself.

The robot 100a and the self-driving vehicle 100b having the self-driving function can use a common sensing method to determine at least one of the travel route or the travel plan. For example, the robot 100a and the self-driving vehicle 100b having the self-driving function can determine at least one of the travel route or the travel plan by using the information sensed through the lidar, the radar, and the camera.

The robot 100a that interacts with the self-driving vehicle 100b exists separately from the self-driving vehicle 100b and can perform operations interworking with the self-driving function of the self-driving vehicle 100b or interworking with the user who rides on the self-driving vehicle 100b.

In addition, the robot 100a interacting with the self-driving vehicle 100b can control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b can monitor the user boarding the self-driving vehicle 100b and the user's emotional state, or can control the function of the self-driving vehicle 100b through the interaction with the user. For example, when it is determined that the driver is in a drowsy state or an angry state, the robot 100a can activate the self-driving function of the self-driving vehicle 100b or assist the control of the driving unit of the self-driving vehicle 100b. The function of the self-driving vehicle 100b controlled by the robot 100a can include not only the self-driving function but also the function provided by the navigation system or the audio system provided in the self-driving vehicle 100b.

Alternatively, the robot 100a that interacts with the self-driving vehicle 100b can provide information or assist the function to the self-driving vehicle 100b outside the self-driving vehicle 100b. For example, the robot 100a can provide traffic information including signal information and the like, such as a smart signal, to the self-driving vehicle 100b, and automatically connect an electric charger to a charging port by interacting with the self-driving vehicle 100b like an automatic electric charger of an electric vehicle. Also, the robot 100a can provide information and services to the user via a digital avatar, which can be personally tailored to the user based on the user's emotional state.

According to an embodiment, the AI device 100 can provide a light transformation based emotion recognition (LTER) AI model which can automatically determine an emotional state of a user.

According to another embodiment, the AI device 100 can be integrated into an infotainment system of the self-driving vehicle 100b, which can recognize different users and their emotional states, and recommend content, provide personalized services or provide answers based on various input modalities, the content can include one or more of audio recordings, video, music, pod casts, etc., but embodiments are not limited thereto. Also, the AI device 100 can be integrated into an infotainment system of the manual or human-driving vehicle.

Emotion recognition (ER) can determine human emotions by analyzing physiological or physical signals. By focusing on non-invasive modalities like facial expressions and voice, emotion recognition can facilitate natural and intuitive human-computer interactions. According to an embodiment, the emotion recognition AI model can leverage audio, visual, and/or language cues to provide insights into a user's emotional state, which can provide more empathetic and personalized computing experiences.

In addition, the AI device 100 can provide automated emotion recognition (ER) which can empower technology with the ability to perceive human emotions. While physiological data like EEG, heart rate and ECG can offer deep insights into emotional states, their invasive nature limits their use in everyday technology. According to an embodiment, the AI device 100 can focus on non-invasive modalities such as facial expressions, vocal tone and/or spoken language, which can be captured by cameras and microphones. By analyzing the collected information, the AI device 100 can detect the emotional state of a user, and enable more natural and empathetic human-computer interaction in various applications, such as home robots and personal assistants.

In addition, the detected emotional state of a user can be utilized by other downstream applications to provide emotionally aware responses, e.g., empathetic conversations or offering mood regulation strategies. Also, the emotion recognition task can be formulated as a multi-label classification task in which multiple basic emotions model complex emotions. The basic emotions can include anger, disgust, fear, happiness, sadness and surprise, but embodiments are not limited thereto.

As discussed above, emotion recognition technology faces several challenges. Many existing models are complex and computationally expensive, hindering real-time use and deployment on devices with limited resources. Additionally, some methods over-rely on textual information, which can be misleading or less informative than audio cues like tone of voice. Also, the use of generic feature extractors can lead to less accurate emotion classification, and transmitting data to remote servers can raise privacy concerns. These issues highlight the need for more efficient, accurate and privacy-preserving approaches to emotion recognition.

According to an embodiment, the AI device 100 implementing the LTER model can focus on the audio modality, which can result in an increase in performance while contributing to a more lightweight model. Also, the AI device 100 can employ a specialized visual feature extractor that is specifically trained to recognize facial expressions. In this way, using a lighter and more specialized visual feature extractor can deliver better outcomes when compared to a more complex feature extractor that has not been trained for the targeted task or a pure transformer architecture that relies on raw input patches. Additionally, the number of parameters of the AI model can be reduced, which provides added benefits.

According to an embodiment, the Light Transformer-based Emotion Recognition (LTER) model can include modality-specific encoders followed by transformer-based towers with cross-attention links between them. The LTER model can further include a fusion block that can fuse the outputs of the transformer towers, and a classifier that outputs the emotional state.

For example, the modality encoders can be used instead of inputting raw modality patches to the transformer model. In this way, utilizing lightweight and specialized modality encoders can improve performance.

In addition, the LTER model can include a pre-trained facial expression recognition model as a specialized light encoder for the visual modality to produce visual embeddings, mel-spectrograms can be used for the audio modality and GloVe-based embeddings can be used for the language modality, which is discussed in more detail below.

Also, according to an embodiment, the text/language modality can be optionally omitted, which can further reduce the model size while minimally impact performance. For example, the language modality may carry the least information for the emotion recognition task. However, for improved accuracy, the text/language modality can be included.

In more detail, the LTER model can improve performance and accuracy by prioritizing a non-language modality (e.g., audio), as the primary source for understanding emotions. Further, dedicated transformer blocks can be employed for each modality, enabling a dynamic cross-modal attention mechanism.

The cross-modal mechanism can allow the primary modality (e.g., audio) to guide the interpretation of secondary modalities (e.g., visual cues) by sharing key information. This can facilitate a richer integration and processing of multimodal information.

Then output vectors generated by the transformer-based modality towers can be summed element-wise (e.g., fusion module) and are then projected over possible answers (e.g., classification module) to predict the expressed emotion. This streamlined architecture can enhance both efficiency and accuracy in emotion recognition.

In addition, according to an embodiment, the LTER model can provide the flexibility of treating the language modality as optional. This approach can offer several benefits. Firstly, it can substantially reduce the overall complexity and size of the model. Secondly, the model can gain speed and operational efficiency by eliminating the requirement for automated speech recognition and subsequent text processing. Further, this option can have a minimal impact on the effectiveness of emotion recognition, as it reduces the lexical bias that often accompanies language processing.

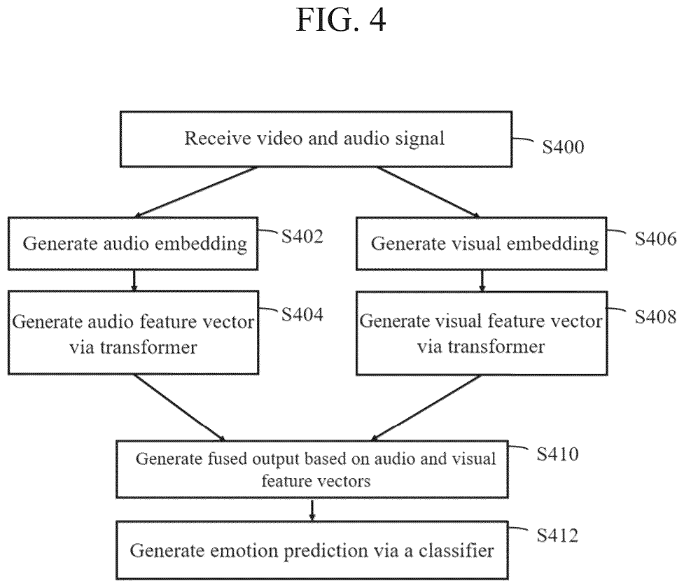

FIG. 4 shows an example flow chart of a method according to an embodiment. For example, according to an embodiment, a method for controlling an AI device to perform emotion recognition can include receiving, by a processor in the AI device, a video segment including a plurality of frames and an audio signal corresponding to the video segment (e.g., S400), processing the audio signal, by an audio encoder, to generate an audio embedding (e.g., S402), and processing the video segment, by a visual encoder, to generate a visual embedding (e.g., S406).

Also, the method can further include processing the audio embedding, by an audio transformer, to generate an audio feature vector, a key matrix and a value matrix (e.g., S404), processing the visual embedding, by a visual transformer, to generate a visual feature vector, in which the processing the visual embedding includes performing cross-attention based on the key matrix and the value matrix from the audio transformer (e.g., S408), generating a fused output using a fusion module that combines at least the audio feature vector and the visual feature vector (e.g., S410), and generating an emotion prediction using a classifier module that analyzes the fused output, and outputting the emotion prediction (e.g., S412). Also, as shown in FIG. 4, steps S402 and S404 can be carried out in parallel to steps S406 and S408. Aspects of the method are described in more detailed below, according to embodiments.

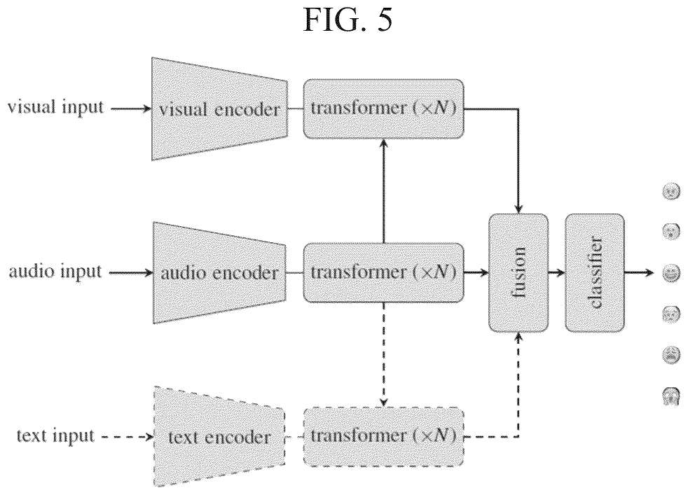

FIG. 5 illustrates an overview of the architecture of an AI model for emotion recognition, according to an embodiment of the present disclosure.

For example, the AI device 100 can include a visual encoder (e.g., visual modality), an audio encoder (e.g., audio modality), and a text encoder (e.g., language modality), and each of the encoders can be connected to a corresponding transformer tower.

In addition, each of the transformer towers can include a plurality of transformer blocks (e.g., four or more). Also, the outputs of the transformer towers can be connected to a fusion block, and the output of the fusion block can be connected to a classifier module that is configured to predict the expressed emotion.

Also, for simplicity or ease of understanding, the transformer tower connected to the visual encoder can be referred to as a visual transformer, the transformer tower connected to the audio encoder can be referred to as an audio transformer, and the transformer tower connected to the text encoder can be referred to as a text transformer.

For example, the AI device 100 can receive a video segment that includes corresponding audio and can automatically determine the dominant emotion that is contained within that segment.

The audio encoder is responsible for processing the audio input and generating representations that capture the emotionally relevant information in the sound.

For example, the audio signal corresponding to a given video segment can include useful information for determining emotions. The audio signal can include speech that is used in conversations to communication information with words but also contains a lot of non-linguistic information, such as nonverbal expressions (e.g., laughs, breaths, sighs, etc.) and prosody features (e.g., intonation, speaking rate, etc.). This provides import information for emotion recognition.

The audio encoder can receive an audio signal as input and generate a mel-spectrogram, which can be converted to a suitable format (e.g., a series of vectors) as input to the corresponding transformer tower. The audio signal can be audio information that is sampled at 16 kHz, but embodiments are not limited thereto.

In more detail, according to an embodiment, the audio encoder can be used to process and represent audio information for enhanced emotion recognition. For example, understanding the nuances of human speech, such as the emotional cues embedded in vocal inflections and tones, can benefit from a representation that aligns with human auditory perception. To achieve this, the LTER model can leverage mel-spectrograms.

For example, a mel-spectrogram can provide visual representations of the frequency content of a sound signal over time. Spectrograms can be generated by applying Fourier analysis to the audio signal, decomposing it into a sum of sinusoids with varying frequencies and amplitudes. By capturing these frequency components and their respective amplitudes over consecutive time windows, a spectrogram can provide a dynamic “picture” of the sound's frequencies in the audio.

Also, human hearing is not linear, rather it is more attuned to changes in lower frequencies than higher ones. The mel-spectrogram addresses this by incorporating the mel scale, which is a perceptual scale that approximates how humans perceive pitch.

Accordingly to an embodiment, the audio encoder can use mel filter banks to compress the spectrogram by allocating higher resolution to lower frequencies and lower resolution to higher frequencies. This results in a representation that is more aligned with human auditory perception, which can be helpful for analyzing emotional cues in speech. For example, the mel-spectrogram can be considered a specialized type of heat map that is tailored to visualize the frequency characteristics of audio signals.

Further, the mel-spectrograms generated by the audio encoder can be extracted using the Librosa library with 80 filter banks, which can capture frequency characteristics of the audio signal in a compact and informative manner. This 80-dimensional representation can be converted into a format suitable for the corresponding transformation tower. For example, the mel-spectrogram can be converted into a sequence of vectors that are input to the transformer tower.

For instance, each column of the mel-spectrogram can be treated as an 80-dimensional vector that is input to the transformer tower. This vector can represent the intensities of the 80 frequency bands for that specific time segment. However, embodiments are not limited thereto, and the mel-spectrogram can be converted or transformed into other formats and data structures that are suitable for use by the corresponding transformer tower according to design considerations and architecture constraints.

With reference again to FIG. 5, the visual encoder can receive a video segment including a plurality of frames as an input and extract deep features from a face crop of an individual or user in the video segment using a facial recognition (FER) model that is specially configured. For example, the video segment can be video captured at 25 frames per second, but embodiments are not limited thereto.

Also, the visual encoder including the FER model can be used for real-time video processing even on a client device, such as a mobile device or smartphone. Since the visual encoder can be implemented locally on a client device, this can improve privacy and security.

According to an embodiment, the FER model can be an EfficientNet-based model (e.g., EfficentNet-B2) that has been designed with a balance between network depth, width, and resolution to improve performance. Also, the FER model can be trained in two stages: pre-training on face recognition and then fine-tuning on emotion classification. For this training, AffectNet dataset can be used, but embodiments are not limited thereto.

For example, according to an embodiment, the FER model can use a EfficientNet-B2 architecture, and be trained to classify facial expressions into eight emotions. To extract features from the face crop of individuals in a video frame, the last hidden layer is used which outputs visual embeddings. The resulting visual embeddings can be 1408-dimensional vectors extracted from each frame. Then, the embeddings can be aggregated by performing an average pool with window size and stride 8. In this way, a more comprehensive representation of an individual's facial features in the video can be obtained.

For example, according to an embodiment, the FER model can use a light weight CNN (e.g., Multi-task Cascaded Convolutional Neural Networks (MTCNN)) for detecting faces, and cropped faces can then be used by a EfficientNet-B2 architecture for emotional feature extraction to generate a vector of facial features, but embodiments are not limited thereto.

For instance, the MTCNN can be in an initial stage of the pipeline to identify and locate faces in the video segment. Then, once the faces are detected, the facial regions (crops) can be obtained from the frames in the video segment. These crops are then further operated on by the FER model for further analysis.

For example, when a facial crop (e.g., an image of a user's face) is input into the FER model, it can process the image and extract a high-dimensional feature vector from a later layer (e.g., the last layer before classification). This feature vector represents the encoded information about the facial features and expressions relevant to emotion recognition.

According to an embodiment, the visual encoder including the FER model can be pre-trained on faces and kept frozen during the emotion recognition training of the LTER model, which can improve performance of the emotion recognition and help better capture intricate facial muscle movements for emotion recognition.

In more detail, the FER model can analyze each frame of a video segment and extracts a visual embedding, e.g., a set of 1,408 numbers that represent the important features of the face in that frame, such as the shape of the eyebrows, the curve of the lips, etc. These numbers can capture the essence of the facial expression.

Then, the FER model can take these visual embeddings from every frame and group them into small sets of 8 consecutive frames. For each group, the FER model can calculate the average of each of the 1,408 numbers across those 8 frames. This average pooling with a stride of 8 means it moves 8 frames ahead for the next group. In this example, the final average for a given group will be a vector of 1,408 numbers (e.g., a 1408-dimensional vector). However, embodiments are not limited thereto and features vectors of smaller or larger dimensions can be used and a stride that is smaller than or greater than 8 can be used, according to design considerations.

Further, by averaging the embeddings over small windows of time, the FER model can obtain a smoother and more complete representation of the user's facial expressions. In this way, the FER model can provide a more comprehensive representation of the user's facial expressions over time (e.g., over a series of frames), which can improve the accuracy of emotion recognition.

For example, once the average feature vector has been generated for a group of frames, it can be transmitted to the corresponding transformer tower (e.g., the visual transformer).

With reference again to FIG. 5, the text encoder (e.g., language modality) can include a speech to text (STT) engine for converting speech input from the inputs audio signal into a text string. Further, the generated text can be tokenized into individual words and converted to all lowercase letters. Also, punctuations and special characters can be excluded, and “unk” can be used for out-of-vocabulary words (e.g., unknown words).

Further, the text encoder can generate a vector embedding for each word in the audio signal. For example, each word can be embedded in a vector of 300 dimensions. GloVe can be used to generate the vector embedding, but embodiments are not limited thereto.

For example, a word embedding can be a dense vector (e.g., a list of numbers) that represents the meaning of a word in vector space which can help show relationships to other words. Words with similar meanings will have similar vectors and be located closer together in the vector space, while dissimilar words will be located farther apart.

In other words, the meaning of words can be represented as points in a multi-dimensional space, in which words with related meanings are positioned closer together, reflecting their semantic similarity. This can allow the model to understand relationships between words by analyzing the distances and directions between these points. For example, the location of each word reflects its meaning and its connections to other words, which can help the model understand the nuances of human language.

Also, the words can be grouped into a segment of audio that corresponds to a given video segment.

Once a vector embedding for a word in the audio segment is generated by the text encoder, the vector embedding can be transmitted to the corresponding transformer tower (e.g., the text transformer).

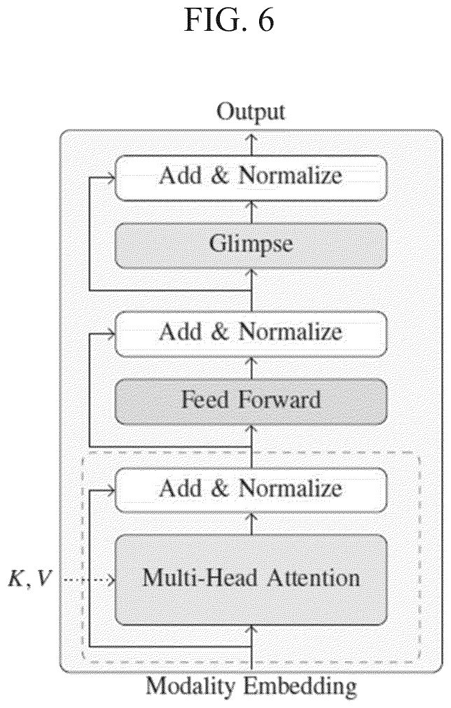

FIG. 6 illustrates an internal architecture of a transformer block, according to an embodiment of the present disclosure. With reference again to FIG. 5, each of the transformer towers can include a plurality of transformer blocks (e.g., N transformer blocks, where N is greater than or equal to 2), in which an individual transformer block is shown in FIG. 6. The transformer block can process and refines the input embeddings (e.g., either audio, visual, or text embedding from the encoders) through a series of operations.

For example, each transformer block, within a transformer tower, can use a combination of attention mechanisms, feed-forward networks, and residual connections to effectively process and refine the input embeddings.

Also, an add and normalize block can be applied after each of the multi-head attention, feed-forward, and glimpse blocks.

In more detail, the multi-head attention block can take the input embeddings and calculate attention scores between different parts of the sequence. It uses multiple heads to attend to different aspects of the input simultaneously. This can allow the model to capture relationships and dependencies between different elements in the sequence, such as how different words in a sentence relate to each other or how different parts of a mel-spectrogram contribute to the overall emotional expression.

Also, according to a preferred embodiment, audio can be set as the primary modality, in which the transformer block connected to the audio encoder performs self-attention, while the transform blocks of the secondary modalities (e.g., visual and text) perform cross-attention using the key (K) and value (V) from the audio transformer, which is discussed in more detail below. However, embodiments are not limited thereto, for example, either of the visual or text/language modalities can be set as the primary modality.

Further, a first add and normalize block can receive the output from the multi-head attention block and add it to the original input embedding (e.g., residual connection) and is normalized. This can help preserve information and improve training stability, and the normalized result can help prevent vanishing or exploding gradients during training. For example, the normalization can adjust the values within a layer to keep them within a reasonable range.

In addition, a first feed forward block can apply a feed-forward neural network to each position in the sequence independently. For example, the feed-forward block can act as a fully connected neural network layer that takes the output from the attention mechanism and further transforms it by applying non-linear transformations, allowing the model to learn complex patterns and improve the final output. In other words, it can help the model lean complex non-linear relationships within the data.

Also, a second add and normalize block can receive the output from the first feed forward block, in which the output of the first feed-forward block is added to its input (e.g., residual connection) and normalized.

Further, a glimpse block can receive the output from the second add and normalize block. For example, the glimpse block can take multiple “glimpses” at the input representation, each focusing on different parts of the input. The glimpse block can use a soft attention mechanism to calculate attention weights for each element in the sequence. Then, outputs from all of the glimpses can stacked together or combined to create a new representation that incorporates information from different perspectives.

In addition, a third add and normalize block can receive the output from the glimpse block, in which the output of the glimpse block is added to its input (e.g., residual connection) and normalized.

For example, the final output of the transformer block is a refined representation of the input sequence which can incorporate information about relationships between different elements and capture complex patterns within the data. This refined representation can then be passed to the next transformer block or to the fusion module for further processing.

For example, the transformer block can receive a sequence of vectors as input (e.g., audio embeddings, visual embeddings, or text embeddings), process this sequence through multi-head attention, feed-forward networks, and glimpse layers, refining the representation and capturing relationships between different elements in the sequence, and then output another sequence of vectors.

Also, the vectors output by the transformer block can have the same length as the input sequence. Each vector in the output sequence can correspond to a vector in the input sequence, but it has been transformed and enriched with contextual information from the entire sequence. The vectors can be 512-dimensional vectors, but embodiments are not limited thereto.

As discussed above, one of the modalities can be set as a primary modality and can use self-attention, while the remaining modalities can be set as secondary modalities and implement cross-attention using the key (K) and value (V) matrices from the primary modality's transformer tower.

In more detail, according to an embodiment, the visual modality and the language modality can attend to the audio information, via a cross attention mechanism by which the model can intelligently focus on and incorporate relevant auditory cues to enhance its understanding of the visual scene or the text/language segment.

For example, in a situation where a person in a video segment is smiling, but his or her voice is trembling. If the model relied solely on the visual information, it might incorrectly interpret the emotion as happy. However, by “attending” to the audio information (e.g., the trembling voice), the visual modality can gain a deeper understanding of the situation. This cross-modal attention allows the LTER model to recognize that the trembling voice indicates nervousness or fear, even though the person is smiling.

In more detail, according to the cross attention mechanism, the audio sequence can produce keys (K) that represent different aspects of the audio information (e.g., pitch, tone, and intensity, etc.). The visual sequence can produce queries (Q) that represent different aspects of the visual information (e.g., facial expressions, mouth movements, etc.). The cross-attention mechanism can then allow the model to match these visual queries with the audio keys to identify the most relevant audio information for each visual element. According to an embodiment, the LTER model can create a weighted sum of the audio values (V), which contain detailed audio information, and integrate this information into the visual representation.

In other words, the cross attention feature can allow the visual and language modalities to use the audio information as a guide to focus on the most important parts of the sequence. In this way, a better informed and more accurate representation of the emotional state can be determined by the model.

With reference again to FIG. 5, the vectors output from the transformer towers (e.g., visual transformer, audio transformer and text transformer) can be input to the fusion module. The integrate the information extracted from the different modalities (e.g., audio and visual) into a unified representation via element-wise summation.

The outputs from the audio and visual processing pipelines include different information about the emotional state. The fusion module can merge these different pieces of information together, which can improve the performance and efficiency of the emotion recognition.

For example, the audio transformer can output a 512 dimensional vector representing audio features and the visual transformer can output a 512 dimensional vector representing visual features. These two vectors can be aligned and pairs of elements from each vector can be added together to create a resulting 512 dimensional vector, which includes this combined information. The resulting 512 dimensional vector can then be transmitted to the classifier module.

The classifier module can receive the fused feature vector from the fusion module. According to an embodiment, the classifier module can be implemented as a fully connected neural network trained to recognize patterns and relationships within the fused representation that correspond to different emotional states.

For example, the classifier module can map the fused representation to a set of probabilities, in which each of the probabilities represent a the likelihood of a specific emotion being expressed. The emotions can include anger, disgust, fear, happiness, sadness, and surprise, but embodiments are not limited thereto. Then, the classifier module can select the emotion with the highest probability as the final prediction, which is based on the combined modalities (e.g., audio and visual, or audio, visual and language).

According to an embodiment, the LTER AI model can be trained using the binary cross-entropy (BCE) loss function. However, embodiments are not limited thereto and other types of loss functions can be used, such as a mean squared error (MSE) loss or focal loss or weighted versions of these losses.

For example, during training, the model can receive labeled data (e.g., a video segment and a corresponding audio signal) in which input sample is associated with a specific emotion category. The LTER model can then predict probabilities for each emotion and compare the results to the true labels, and the binary cross-entropy loss can quantify the difference between the predictions and the ground truth.

The loss value can guide the optimization process which can include iteratively adjusting the model's internal parameters to minimize the difference between its predictions and the true emotional labels. By repeatedly evaluating the loss and updating the model's parameters, the LTER model gradually learns to accurately recognize emotions from the input multimodal data, effectively minimizing the binary cross-entropy loss and improving its performance over time.

During inference time, the process is similar, except the loss function is not computed and the final predication is used as the output.

Various experiments were carried out against related art emotion recognition models (e.g., a textless vision-language transformer (TVLT) model and a transformer-based joint-encoding (TBJE) model) and different embodiments of the LTER model where the orderings of the primary and secondary modalities were adjusted or changed.

As shown in Table I below, the LTER AI model according to embodiments outperforms other methods.

TABLE I

| | | | Happy | | Sad | | Angry | | Fear | | Disgust | | Surprise | | Average | |
|---|---|---|---|---|---|---|---|---|---|---|---|---|---|---|---|---|
| Method | Modality | # params | Acc. | F1 | Acc. | F1 | Acc. | F1 | Acc. | F1 | Acc. | F1 | Acc. | F1 | Acc. | F1 |
| TVLT [20] | A [symbol] V | 88.6 | 65.1 | 64.1 | 72.2 | 70.0 | 69.9 | 72.1 | 68.1 | 88.0 | 68.8 | 79.6 | 62.1 | 87.4 | 67.7 | 76.8 |
| TBJE [6] | L, A, V | 128.3 | 65.0 | 64.0 | 72.0 | 67.9 | 81.6 | 74.7 | 89.1 | 84.0 | 85.9 | 83.6 | 90.5 | 86.1 | 80.6 | 76.7 |
| LTERᵥₐₗ | V, A, L | 52.98 | 60.9 | 60.1 | 66.4 | 65.8 | 72.8 | 74.8 | 86.8 | 88.3 | 80.6 | 81.3 | 88.1 | 89.6 | 75.9 | 76.6 |
| LTERᵥₐ | V, A | 35.95 | 56.2 | 56.1 | 66.8 | 67.6 | 67.9 | 78.9 | 87.5 | 89.8 | 77.7 | 79.1 | 88.2 | 89.9 | 74.0 | 76.9 |
| LTERₐᵥₗ * | A, V, L | 52.98 | 58.8 | 59.8 | 75.6 | 86.2 | 76.4 | 86.0 | 90.5 | 95.0 | 82.2 | 90.0 | 91.6 | 95.6 | 79.5 | 86.7 |
| LTERₐᵥ * | A, V | 35.95 | 62.8 | 62.9 | 70.4 | 71.9 | 74.8 | 78.9 | 89.6 | 93.1 | 82.1 | 84.6 | 90.1 | 92.9 | 78.3 | 80.7 |

[symbol]

indicates data missing or illegible when filed

As shown above, the results include the accuracy, weighted F1 for each emotion category, and average scores for comparisons between the models. Also, the number of parameters used during testing is included and the modality encoders, which can be viewed as a proxy for the size of the different models. The naming convention lists modalities as subscripts (e.g., A for audio, V for visual, and L for language), with the primary modality first. For example, LTERav1 uses all three modalities, and audio is the primary modality.

Also shown above, omitting the language modality does not significantly affect the model's performance (e.g., LTERav1 vs LTERav). Thus, omitting the language modality can significantly reduce model size while only slightly lowering performance.

In addition, treating audio as the primary modality according to the embodiment discussed above outperforms the model with visual primary modality, e.g., compare LTERav1 vs. LTERva1 and LTERav vs. LTERva.

Also, during the evaluation, LTERav1 model had 52.98 million parameters, and the LTERav had 35.95 million parameters, which is considerably less than the TVLT and TBJE models. As shown above, eliminating the language modality can reduce model size by 66%. However, this reduction did not significantly impact the average scores.

The complexity of the visual encoders can be approximated by the number of parameters between the proposed LTER model, and the related art TVLT and TBJE models. The TBJE model has the most complex visual encoder, followed by the LTER model. The TVLT model uses raw patches of the input visual frames. The average scores and model size show that a smaller, more specialized feature extractor model is more helpful.

Also, according to the embodiment, using the FER model as an encoder, pre-trained on faces and kept frozen during the ER training, outperforms a more complex visual encoder trained on Kinetics and Sports-1M of the TBJE model. Although the Kinetics and Sports-1M datasets capture human movements, the trained encoder for the TBJE model may not be able to capture intricate facial muscle movements for emotion recognition, in contrast to the smaller and more specialized FER encoder of the LTER model which can capture these intricate features.

Also, the TVLT model does not use modality encoders and the transformer blocks encode the information in the patches and the relations between them. The evaluation results show that using a small but specialized visual feature extractor helps with the overall performance of the transformer-based systems.

Accordingly, both versions of the LTER model (e.g., LTERav1 and LTERav) according to embodiments, outperform the TBJE and TVLT models in average F1 scores. For example, the LTERav1 and LTERav models outperform the TVLT model in average accuracy and perform comparably to TBJE but have smaller size.

According to an embodiment, the AI device 100 can be configured to automatically determine an emotional state of a subject based on a video/audio segment. The AI device 100 can be used in various types of different situations.

According to one or more embodiments of the present disclosure, the AI device 100 can solve one or more technological problems in the existing technology, such as automatically determining a user's emotional state and providing tailored services based on the emotional state, in a more efficient and secure manner.

Also, according to an embodiment, the AI device 100 configured with the LTER AI model can be used in a mobile terminal, a smart TV, a home appliance, a robot, an infotainment system in a vehicle, etc.

Further, according to an embodiment, the AI device 100 including the LTER model can implement a method that can provide a more efficient, accurate and privacy-conscious solution for emotion recognition.

For example, the AI device can be applied in a wide range of interactive applications including a digital assistant, a question and answering system, and a home robot. For example, according to an embodiment, the home robot can determine the user's emotional state and based on this information, the robot can perform a more relevant helping or caring action, or provide a better answer or information that more accurately addresses the user's needs.

Various aspects of the embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

Furthermore, although some aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, PHP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A method for controlling an artificial intelligence (AI) deice, the method comprising:
receiving, by a processor in the AI device, a video segment including a plurality of frames and an audio signal corresponding to the video segment;
processing the audio signal, by an audio encoder, to generate an audio embedding;
processing the video segment, by a visual encoder, to generate a visual embedding;
processing the audio embedding, by an audio transformer, to generate an audio feature vector, a key matrix and a value matrix;
processing the visual embedding, by a visual transformer, to generate a visual feature vector, wherein the processing the visual embedding includes performing cross-attention based on the key matrix and the value matrix from the audio transformer;
generating a fused output using a fusion module that combines at least the audio feature vector and the visual feature vector; and
generating an emotion prediction using a classifier module that analyzes the fused output, and outputting the emotion prediction.

2. The method of claim 1, wherein the processing the video segment by the visual encoder includes:
extracting, via a facial expression recognition (FER) model in the visual encoder, a plurality of visual embeddings corresponding to the plurality of frames in the video segment;
averaging at least some of the plurality of visual embeddings over a time window to generate an average feature vector corresponding to a group of frames; and
transmitting the average feature vector to the video transformer.

3. The method of claim 2, wherein the FER model is trained in two stages that include pre-training on face recognition and then fine-tuning on emotion classification.

4. The method of claim 1, wherein each of the audio transformer and the visual transform is a transform tower including a plurality of transformer blocks.

5. The method of claim 4, wherein each of the plurality of transformer blocks includes a multi-head attention block, a first add and normalize block, a feed forward block, a second add and normalize block, a glimpse block, and a third add and normalize block.

6. The method of claim 1, wherein the generating the fused output using the fusion module includes element-wise summing the audio feature vector and the visual feature vector to generate the fused output.

7. The method of claim 1, further comprising:
inputting the audio signal to a speech to text (STT) engine to convert speech included in the audio signal to text;
processing the text, by a text encoder, to generate a text embedding;
processing the text embedding, by a text transformer, to generate a text feature vector, wherein the processing the text embedding includes performing cross-attention based on the key matrix and the value matrix from the audio transformer; and
generating the fused output using the fusion module to combine the audio feature vector, the visual features vector and the text feature vector.

8. The method of claim 7, wherein each word in the text is embedded in a vector of 300 dimensions based on GloVe.

9. The method of claim 1, wherein the generating the emotion prediction using the classifier module includes:
mapping the fused output to a set of probabilities corresponding to a plurality of emotions; and
selecting an emotion among the plurality of emotions having a highest probability as the emotion prediction.

10. The method of claim 9, wherein the plurality of emotions include anger, disgust, fear, happiness, sadness and surprise.

11. An artificial intelligence (AI) device, comprising:
a memory configured to store video and audio information; and
a controller configured to:
receive a video segment including a plurality of frames and an audio signal corresponding to the video segment,
process the audio signal, by an audio encoder, to generate an audio embedding,
process the video segment, by a visual encoder, to generate a visual embedding,
process the audio embedding, by an audio transformer, to generate an audio feature vector, a key matrix and a value matrix,
process the visual embedding, by a visual transformer, to generate a visual feature vector based on performing cross-attention using the key matrix and the value matrix from the audio transformer,
generate a fused output using a fusion module that combines at least the audio feature vector and the visual feature vector, and
generate an emotion prediction using a classifier module that analyzes the fused output, and output the emotion prediction.

12. The AI device of claim 11, wherein the controller is further configured to:
extract, via a facial expression recognition (FER) model in the visual encoder, a plurality of visual embeddings corresponding to the plurality of frames in the video segment,
average at least some of the plurality of visual embeddings over a time window to generate an average feature vector corresponding to a group of frames, and
transmit the average feature vector to the video transformer.

13. The AI device of claim 12, wherein the FER model is trained in two stages that include pre-training on face recognition and then fine-tuning on emotion classification.

14. The AI device of claim 11, wherein each of the audio transformer and the visual transform is a transform tower including a plurality of transformer blocks.

15. The AI device of claim 14, wherein each of the plurality of transformer blocks includes a multi-head attention block, a first add and normalize block, a feed forward block, a second add and normalize block, a glimpse block, and a third add and normalize block.

16. The AI device of claim 11, wherein the controller is further configured to:
generate the fused output by element-wise summing the audio feature vector and the visual feature vector to generate the fused output.

17. The AI device of claim 11, wherein the controller is further configured to:
input the audio signal to a speech to text (STT) engine to convert speech included in the audio signal to text,
process the text, by a text encoder, to generate a text embedding,
process the text embedding, by a text transformer, to generate a text feature vector based on performing cross-attention using the key matrix and the value matrix from the audio transformer, and
generate the fused output using the fusion module to combine the audio feature vector, the visual features vector and the text feature vector.

18. The AI device of claim 17, wherein each word in the text is embedded in a vector of 300 dimensions based on GloVe.

19. The AI device of claim 11, wherein the controller is further configured to:
map, via the classifier module, the fused output to a set of probabilities corresponding to a plurality of emotions, and
select an emotion among the plurality of emotions having a highest probability as the emotion prediction.

20. The AI device of claim 19, wherein the plurality of emotions include anger, disgust, fear, happiness, sadness and surprise.
